(19) United States
(12) Patent Application Publication
(10) Pub. No.: US 2008/0241326 A1
(43) Pub. Date: Oct. 2, 2008

(54) APPARATUS, SYSTEM, AND METHOD FOR A BREAD CUTTER AND IMPRESSION DEVICES

(76) Inventor: Lane Ekberg, Salt Lake City, UT (US)

Correspondence Address: Kunzler & McKenzie, 8 EAST BROADWAY, SUITE 600, SALT LAKE CITY, UT, 84111, US

(21) Appl. No.: 12/056,082

(22) Filed: Mar. 26, 2008

Related U.S. Application Data
(63) Continuation-in-part of application No. 11/615,725, filed on Dec. 22, 2006.
(60) Provisional application No. 60/896,953, filed on Mar. 26, 2007.

(51) Int. Cl. A23P 1/00; A47J 43/04; A23P 1/10

(52) U.S. Cl. 426/512; 99/485; 99/450.4

(57) ABSTRACT

A sandwich sealing crust removing method and apparatus also include bread marking and imaging mechanisms for one or more of indenting, embossing, coloring, cutting, and forming. The apparatus is capable of cutting the crust from a prepared sandwich having filling ingredients between at least two slices of bread in the sandwich. The cut edge area on the sandwich is also sealed to insure that the filling ingredients stay within a pocket formed in the bread. One or more element of the apparatus is also capable of embossing images onto the sandwich and/or a bread slice(s). One of a plurality of devices has removably coupled marking elements that can be used on sandwiches. The marking elements may include one or more removably coupled elements for shaping, marking, embossing, cutting, coloring, indenting, and/or other mechanism(s).

### CROSS-REFERENCES TO RELATED APPLICATIONS

This application claims priority to U.S. Provisional Patent Application No. 60/896,953, entitled “APPARATUS, SYSTEM, AND METHOD FOR A BREAD CUTTER AND IMPRESSION DEVICES”, filed on Mar. 26, 2007 for Lane Ekberg, and is a continuation-in-part of and claims priority to U.S. patent application Ser. No. 11/615,725, entitled APPARATUS, SYSTEM, AND METHOD FOR MAKING SANDWICHES, filed Dec. 22, 2006, for Lane Ekberg et al., which are incorporated herein by reference.

### BACKGROUND OF THE INVENTION

1. Field of the Invention

This invention relates to the field of devices for indenting, embossing, shaping, cutting, and marking baked bread slices, and more particularly to devices for indenting, cutting, and marking baked bread slices by any of a variety of specific mechanisms and in accordance with any of a variety of specific methods.

2. Description of the Related Art

Food indenting, marking, and embossing are well known in the art. Many devices and methods provide a user with food and bread markings that are painted, iced, embossed, or marked on the surface of dough prior to baking. The devices that are available for carrying out these methods on bread slices are complex. Some devices also include cutting blades as part of their mechanisms for indenting, marking, and embossing.

While these bread-manipulating elements mentioned above may be effective, they are also too complicated for many applications and for use by children. They are also costly to manufacture. Some of these devices and methods even include cutting features that could be dangerous for children.

Current bread indenting and embossing products are meant for use with dough though some products claiming to be food stampers and indenters do not work well with baked, sliced bread and have complicated settings that are incompatible with use by children and most adults. The current products that claim to be food stampers turn out sandwiches of inferior quality. Additionally, all of the current solutions discovered by others in the art are very expensive and difficult to manufacture.

### SUMMARY OF THE INVENTION

From the foregoing discussion, it should be apparent that a need exists for an apparatus, system, and method that cut, seals, and/or shapes food products including bread slices or layers, cakes, pasta, dough products, pizza, pizza pockets, brownies, cookies, etc. Beneficially, such an apparatus, system, and method would cut, seal, and/or shape the food products in a single action performed with a hand held and hand manipulated apparatus, and may be capable of selectively forming any of a variety of images including one or more or images of cartoon characters, alphabet letters, logos, and/or other details.

The present invention has been developed in response to the present state of the art, and in particular, in response to the problems and needs in the art that have not yet been fully solved by currently available devices and methods discovered by others. Accordingly, the present invention has been developed to provide an apparatus, system, and method for cutting, sealing, and/or shaping food products in general, bread, and sandwiches in particular that overcome many or all of the above-discussed shortcomings in the art.

For example, products developed by others in the past, which are purported to be food stampers, actually “smash” sandwiches that contain filling during the indenting process, causing the filling to escape from the sides of the sandwich. Thus, a solution to the problems of a good bread slice and sandwich marking, indenting, or embossing device requires providing one that does not overly crush the bread slice or sandwich, and a solution that doesn't allow the filling to escape from a sandwich. Furthermore, embodiments include a device that slices and seals an edge of the sandwich or other food product in addition to embossing. Disclosed is a food product marking, indenting, and embossing device that is easy to manufacture and has no moving parts. Additionally, the device has structure that slices and seals an edge of the food product to retain ingredients within while also being safe for children to use. Furthermore, the device is inexpensive to manufacture.

Also needed is a device with which an image can be selectively omitted from a sandwich or other food product by using a cut and seal mechanism without indenting or embossing elements. When the cut and sealing device is lowered over a sandwich, for example, its cutting edge has the ability to seal the edge when cut, thus holding the sandwich filling ingredients inside. In embodiments of the invention, however, the device is configured to work in tandem with an additional sandwich making apparatus. What is additionally needed is a cut and seal device that is equipped within its configuration to cut and seal images of letters, animals, logos, etc, and within any cut configuration additional indenting element(s) may be present on the device. For example, the shape of a car could be cut and sealed out of a sandwich and the detail of the entire tires and windows can be formed by the indenting, embossing, and marking elements selectively added to the cut and seal shaping mechanisms. More generally, the prepared food product may have an outline of a vehicle, a symbol, or an animal forming an outline of an image. Images on the marking elements may be related to the outline of the image in order to form a matching overall image shape and outline for the prepared food product.

What is also needed is an indenting, marking, and embossing means for baked bread that can be removably coupled to the bread cutter or to a cookie cutter. This device may also be used on dough, pastries, pie, pasta, and foods of other types.

The present invention is in response to the present state of the art, and in particular, in response to the problems and needs in the art that have not been fully solved by current sandwich makers, cut and seal devices, and emboss, indent, marking devices. Accordingly, the present invention has been developed to provide very effective bread and other food product shaping and marking devices that can be enjoyed by children and/or adults. Devices in accordance with embodiments of the present invention are especially designed for those seeking to enhance the shape and look of bread sandwiches and other foods in ways previously not possible.

A solution to the problems of a good food product, bread slice, and sandwich marking, indenting, or embossing device is to provide one that does not overly crush the bread slice or sandwich and that inhibits the filling from escaping from a sandwich. Embodiments of the present invention accomplish this, as may be appreciated from this disclosure.

In one embodiment, the present invention includes indenting, marking, or embossing features implemented through a simple handle of a hand held device, which a human hand can manipulate for forming one or images and/or other shapes in baked bread without any movable parts. The device works on any configuration of baked bread and has no limit on how far the user wants to push an image into the surface of the bread. The greater the depth to which a user pushes the marking device into the bread, the bolder the image becomes.

In some embodiments the device has no moving parts. In other embodiments, the device has removable parts such as selectively removable and changeable embossing elements. In still other embodiments, the embossing element is adjustable and can be moved to increase or decrease an indenting depth. Embodiments of the invention enable a user to selectively cut and/or selectively seal any of a variety of food products including bread and sandwiches. In one embodiment, the devices of the present invention enable custom configuration of the devices to generally match a bread slice or other food product size. This may be accomplished by elements that can be added or removed to adjust an outer edge of the resulting shaped, cut, and/or sealed food. Thus, the elements or other structure that enable custom configuration also enable a user to selectively choose the size of the resultant food that he or she is shaping, cutting, and/or sealing.

Another embodiment includes a bread-cutting device that can cut the bread into various shapes and sizes, and furthermore can indent, emboss, and/or mark the surface of the bread. The bread may be in a sandwich configuration with food filling between at least two slices of bread. Additionally, the cutting edge of the device may also seal the edge of the bread, preventing or inhibiting food ingredients from leaking from the sides of the shaped bread slices. This “cutting and sealing” and “embossing, marking, indenting, etc,” may be done with a device that is placed over one side of the sandwich or bread slice so that the periphery of the bread is outside the cutting and sealing area. Another embodiment is one that provides a device that fully surrounds the bread slice or sandwich.

Another embodiment of the present invention includes a sandwich making device that has an upper tool and a lower tool that surround both sides of at least one slice or layer and causes marking, indenting, and/or embossing on both sides of the slice or layer of bread, or on both sides of a sandwich. Alternatively, the device may apply the markings to a single side of the bread. This device, with an upper and lower tool, may or may not cut and seal the periphery of the bread slice and may or may not remove the crust. In one embodiment, the upper and lower tools pivot between an opened position and a closed position. The upper and lower tools may also surround dough products such as scones and donuts, shaping them and placing markings, embossings, and/or detail into the food products. This handheld shaping device may also be useful in non-food areas as well such as sand, cement, and so on.

A further embodiment is a device that has a hand holding feature and that indents baked bread. The hand holding feature or “handle” may have releasably coupled indenting, marking, or embossing elements that can be easily removed and switched with other elements having different shapes and sizes of bread markings. Simple plastic snap mechanisms, suction cups, and/or the magnets may be used as coupling mechanisms, although any of a multitude of additional or alternative mechanisms for releasably coupling the elements may be implemented instead.

A further embodiment includes a device for indenting, marking, and/or embossing bread of hot dog buns and hamburger buns. The device may hold the buns and seal their edges and mark their surface with any of a variety of images through indenting, embossing, and/or marking in accordance with some means explained previously or in other embodiments described herein.

Another feature in accordance with embodiments of the present invention is the simplicity of manufacturing. Generally the device can be made with food grade injection molded plastics. Many other materials may also be suitable for constructing these food and bread marking devices that were previously unknown in the industry.

Another embodiment includes a “cookie cutter” type bread shaping and cutting device with indenting, marking, and/or embossing in a center region of the cut or shaped bread slice or sandwich. The cutting in accordance with this embodiment may also be used to remove the crust of the sandwich and at the same time place an image into the sandwich that is embossed, indented, and/or marked. An image forming element may be optional and/or selectively removable.

In a simple form, embodiments of the invention may include a device for marking images onto sandwich bread in which the device. In this simple from, the device may include a tool having a mechanism for shearing a crust from baked, sliced bread. The tool may have a mechanism for sealing a sheared edge of the sliced bread and an image marking element. The image marking element may be configured to imprint an image into an outer surface of at least one bread slice. Embodiments may include two or more of the shearing mechanism, sealing mechanism, and a marking mechanism including the marking element configured to simultaneously shear, seal, and/or mark bread to form a sandwich having a pocket containing a filling on an inside and an image on an outside.

The image marking element may be one of a plurality of image marking elements that can be removably coupled to the tool by a releasable coupling mechanism. Thus, in another simple form the device enables a multitude of imaging and embossing options.

In another simple form, embodiments of the invention include a system for forming a sealed edge sandwich. The system may include a hand held device having at least one blunt shearing edge. The hand held device may further include at least one crimping face surrounded by the at least one blunt shearing edge and an at least one recess surrounded by the at least one blunt shearing edge and positioned inwardly of the at least one crimping face.

In one embodiment, the hand held device includes a first tool that includes the at least one blunt shearing edge, the at least one crimping face, and the at least one recess. In this embodiment, the device further includes a second tool that includes a second blunt shearing edge, a second crimping face surrounded by the second blunt shearing edge, and a second recess surrounded by the second blunt shearing edge and positioned inwardly of the second crimping face. The system may further include the set of detachable marking elements and a releasable coupling mechanism on the hand held device and detachable marking elements for releasably coupling the marking elements to the device. The set of detachable marking elements may include for user selection, images of one or more of a cartoon, letter, number, logo, and a human interest image.

In one aspect of the system the first tool may be an upper tool, and the blunt shearing edge may form an outline of a predetermined familiar image configured to elicit positive emotion when perceived. The upper tool is configured to be brought down upon a food product resting on a counter or a lower tool to sever a portion of the food product in order to leave the outline of the image on a prepared food product. In this aspect, the crimping face on the upper tool is surrounded by the at least one blunt shearing edge, and is configured to press layers of the food product together around a food product filling to form the prepared food product with a sealed pocket of filling between the layers. The recess in the upper tool is surrounded by the at least one blunt shearing edge and positioned inwardly of the at least one crimping face such that the recess shapes the food product in order to form an image on an outer surface of the prepared food product. In this aspect, the blunt sheering edge, the crimping face, and the recess have relative structure that causes shearing, sealing and shaping to occur simultaneously when the hand held device is brought down on the food product and pressed against the counter or lower tool. Thus, a fun prepared food product having an outline of the predetermined familiar image, a sealed pocket of filling within, and a shaped image on the outer surface is formed by the hand held device.

Reference throughout the specifications to features, advantages, or similar language does not imply that all of the features and advantages that may be realized with the present invention should be or are in any single embodiment of the invention. Rather, language referring to the features and advantages is to mean that a specific feature advantage or characteristic described in connection with the present invention. Thus, discussion of features and advantages, and similar language, throughout this specification may, but do not necessarily, refer to the same embodiment.

Furthermore, the described features, advantages, and characteristics of the invention may be combined in any suitable manner in one or more of the embodiments. One skilled in the art will recognize the invention may be practiced without one or more of the specific features or advantages of a particular embodiment. In other instances, additional features, and advantages may be recognized in certain embodiments that may or may not be present in all of the embodiments of the present invention.

A method of the present invention is also presented for cutting, sealing, and/or shaping bread. The method in the disclosed embodiments may include the steps necessary to carry out the functions presented above with respect to the operation of the described apparatus and system. In one embodiment, the method includes both sealing a contents within a sandwich and shaping a surface of the sandwich with an image is attractive to a child. The method also may include associating a sense of fun with eating a sandwich that has been shaped in accordance with a method of the present invention.

One embodiment of a method of making a sandwich includes identifying a need in a child or other person and simultaneously shearing away portions of the sandwich, sealing an outer edge of the sandwich, and placing an image on an outer surface of the sandwich based on the need. In this embodiment, the method of may include selecting a marking element from a set of marking elements based on the need and removably coupling the marking element to a surface in a food receiving recess of a device.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a top perspective view illustrating one embodiment of a sandwich bread marking device in accordance with the present invention.

FIG. 2 is a bottom perspective view illustrating one variation of the embodiment of the sandwich bread marking device of FIG. 1 in accordance with the present invention.

FIG. 3 is a top plan view illustrating a slice of bread or top of a sandwich that has been embossed, indented, or marked with the marking device of FIG. 2.

FIG. 4 is a perspective view illustrating a “cut and seal” device wherein the crust of sandwiches may be removed, the periphery of the sandwich edge sealed, and the top or bottom of the bread slices embossed or marked inside of a cut and sealed periphery.

FIG. 5 is a perspective view of a “cut and seal” shaper device configured to surround an entire cut portion and to indent, emboss, etc. in accordance with an embodiment of the present invention.

FIG. 6 is a perspective view of a “cookie cutter” type bread slice or sandwich cutter having an optional marking element that includes a releasable coupling mechanism configured to selectively secure the marking element to the cutter in accordance with an embodiment of the present invention.

FIG. 7 is a perspective view illustrating of a food shaper that fully surrounds and shapes food product and has an optional marking element that includes a releasable coupling mechanism configured to selectively attach one or more of marking, imaging, embossing, and/or indenting elements in accordance with an embodiment of the present invention.

FIG. 8 is a bottom perspective view of a bread slice crust removing and edge sealing device having two spaced apart walls in which an outer wall cuts and an inner wall seals an edge of the cut bread in accordance with an embodiment of the present invention.

FIG. 9 is a top plan view illustrating a sandwich having the crust cut by the outer wall and the edge sealed by the inner wall of the device of FIG. 8 in accordance with a method of the present invention.

FIG. 10 is a diagrammatic view of an example set of marking elements configured to be removably coupled to a device of any of the embodiments of the present invention.

FIG. 11A is a diagrammatic partial sectional view of a sandwich maker in accordance with an embodiment of the present invention with the sandwich maker in a partially closed position.

FIG. 11B is a diagrammatic partial sectional view of the sandwich maker of FIG. 10A in a fully closed position.

FIG. 11C is a top plan view of a sandwich formed by a device in accordance with embodiments of the present invention, an example of which is depicted in FIGS. 11A and 11B.

FIG. 11D is a partial sectional view of a tool in accordance with an alternative embodiment of a releasable coupling mechanism.

FIG. 11E is a diagrammatic view showing outlines of cups, crimping faces, and shoulders for a variety of tool configurations and resulting food product outlines.

FIG. 12 is a flow chart diagram showing a method of use of the invention in accordance with an embodiment of the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are described to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

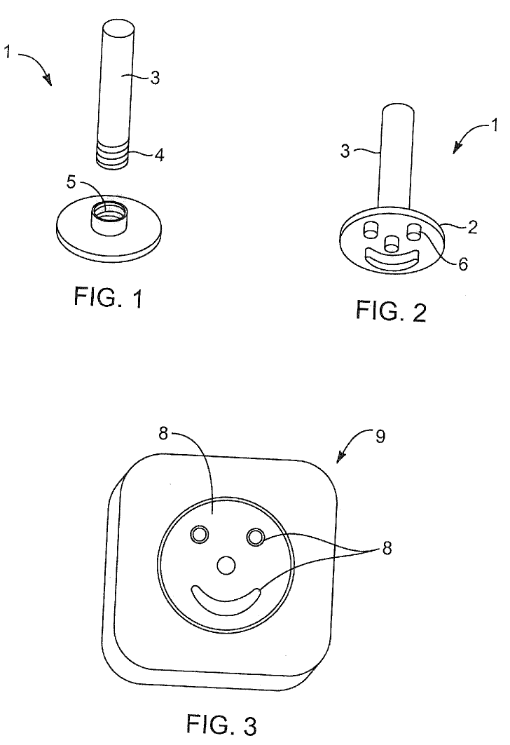

FIG. 1 is a perspective view of a bread molding device in the form of a hand held bread stamp 1 that functions as a unitary tool having no moving parts. A handle 3 can detach from a stamping die or marking element 2 by unscrewing threads 4 of the handle 3 from threads 5 in the die or marking element 2. Thus, a threaded or other releasable mechanism can removably couple any of a plurality of bread slice and sandwich stamping dies. In fact, the hand held stamp 1 may include a multitude of dies or other marking elements 2 having a variety of symbols, logos, letters, characters, pictures, etceteras, from which to choose. The die or other marking element 2 can emboss, indent, cut, mark, or color, any image onto bread slices and sandwiches. The die bread stamp 1 can also be used on other foods such as fruit, pastries, pizza, and the like.

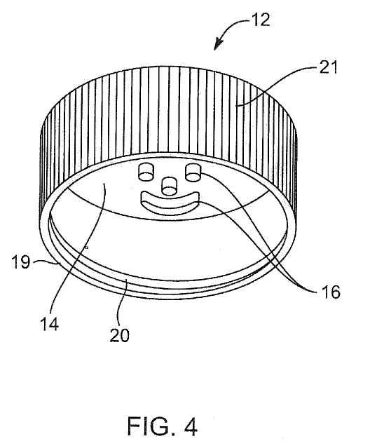

FIG. 2 is a bottom perspective view of the bread stamp 1 in accordance with the present invention showing the handle 3 attached to a die or other marking element 2 having a smiley face 6 in positive relief disposed on the lower surface of the stamping die or other marking element 2. Whatever contour, in this case the smiley face, is an image maker 6. A multitude of images can be configured on a multitude of dies marking elements 2. The user simply holds the handle 3 with their hand to press the die or marking element 2 portion and image maker 6 into the bread slice with any desired degree of pressure to achieve an image marking on the bread slice.

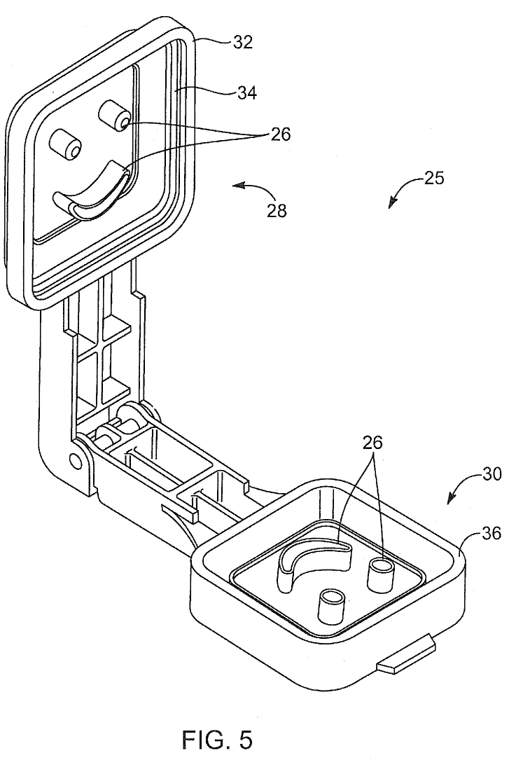

FIG. 3 is a top plan view illustrating an embodiment of a bread slice 7 and the marked embossed image 8 on the slice of bread 7. The embossed image 8 leaves discernable marks mirroring the image from the die or marking element 2 in negative relief in that can easily be seen on the bread slice 7. The bread stamp 1 has no moving parts that are required for the stamping process, and the dies or marking elements 2 can easily be swapped out for a wide range of marking capabilities. For example, some dies may be dipped in an icing or other coating that has coloring prior to stamping so as to color a stamped image. Other dies may include sharp elements that actually cut or sculpt the slice of bread.

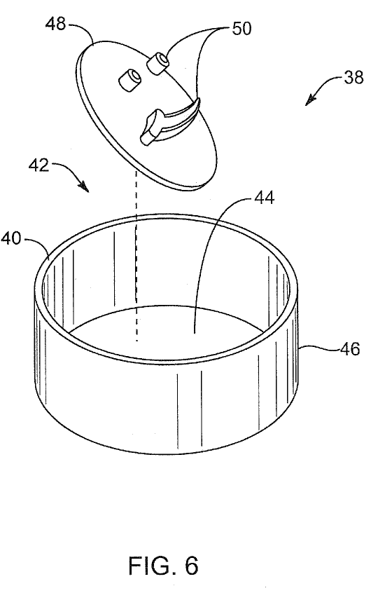

FIG. 4 is a bottom perspective view of a sandwich maker 12 that includes a sandwich crust remover and edge sealer in one device. The sandwich maker 12 also has embossing mechanism built into a bread engaging surface 14, which may be similar to the mechanisms applied to the dies or marking elements 2 of the bread stamp 1. Thus, an image maker 16 may be provided in positive relief configured to sink into the surface of the sandwich or slice of bread to such a depth as to leave a mirrored negative relief marking, embossment, indentation, or anything that can place and image onto the bread slice. Additional or alternative coloring mechanisms can also be utilized in place of or in addition to the embossment, indention, or physically shaped marking mechanisms. A cutting edge 19 cuts the shape out of the sandwich or slice of bread. A step 20 may be incorporated into the sandwich maker 12 in order to provide the edge sealer. The edge sealer presses an edge of the bread sufficiently to cause it to unite with another slice of bread forming another layer of the sandwich, for example, and seal the two slices or layers of the sandwich around any contents placed between the slices. It is to be understood that one slice can be used and folded in half to produce the needed layers. Alternatively, more than two slices or layers of bread can be sealed or united in the sandwich formed with the sandwich makers of the present invention. In accordance with embodiments of the invention, sandwiches and slices can be cut and sealed about an outer periphery surrounding any contents previously placed between layers. This insures that a filling inside the sandwich does not escape and is sealed inside a pocket formed within the sandwich.

The cutting edge 19 may be rounded with a relatively small radius of curvature and/or may have a flat face that is relatively blunt. However, the cutting edge may have a wall thickness of a relatively small dimension to facilitate the cutting operation. Thus, when a user pushes the sandwich maker 18 into a sandwich in a “cookie cutter style” the bread crust is removed. The edge of the bread that remains in tact with the rest of the sandwich is compressed into a volume defined between the step 20 and a cutting surface under the operation of the edge sealer. Thus, the edge is sealed and a decorative marking is placed on a center or other region of the sandwich or bread slice. Indeed, other areas on the surface of the sandwich can also be marked. A texture 21 may be provided on an outer surface of the sandwich maker 18 in order to give better gripping characteristics for the user. The edge sealer provided by step 20 may also be configured to crimp bread in a decorative pattern such as those found on pies. As with the bread stamp 1 described above, the sandwich maker 18 in this embodiment, has no moving parts. Rather, the sandwich maker 18 may be configured as a single unitary piece that is capable of being pressed into a sandwich lying on any flat, generally rigid surface in order to achieve a final sandwich product in accordance with an embodiment of the present invention.

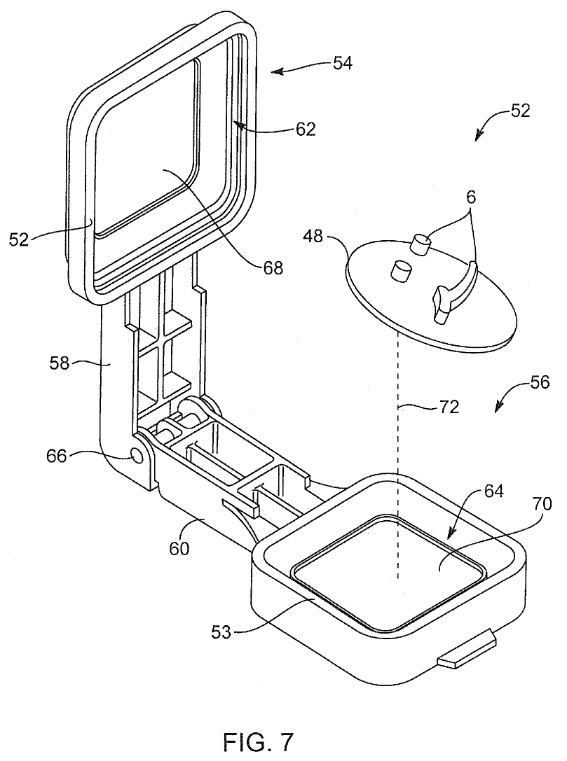

FIG. 5 is a perspective view of a sandwich maker 25 having a crust removing mechanism and a sandwich sealing mechanism that can be operated simultaneously by a single action. The sandwich maker 25 is configured to fully surround a prepared sandwich, remove the crusts, and seal two or more bread slices or layers together. This forms a pocket between the layers of bread for food filling ingredients such as peanut butter and jam, for example. The sandwich maker 25 also has a marking mechanism that embosses, indents, carves, or otherwise forms images in one or more surface of the sandwich. An image maker 26 is pressed into the bread when the sandwich maker 25 is placed in a closed position by applying a force that moves an upper tool 28 toward a lower tool 30. When the upper and lower tools 28, 30 come together, the image maker 26 engages outer surface(s) of a filled sandwich and embosses, marks, colors, and/or indents, one or both sides of the sandwich depending on whether the image maker is on one or both tools 28, 30.

A cut and seal portion of the sandwich maker 25 separates a center region of a sandwich from an outer edge of the bread, which may include the crust. The seal and cut portion also seals a periphery of the prepared sandwich. The cut and seal portion thus includes a cutting edge 32 similar to the cutting edge 19 described with regard to FIG. 4 above, and a step 34 similar to the step 20 also described with regard to FIG. 4 above. The cutting edge 32 is not a sharp element like known blades, but may be rounded or flat faced and relatively blunt. The step 34 forms an edge sealer that acts to press or crimp an outer periphery of the remaining sandwich simultaneously with a severing action performed by the cutting edge 32. A volume defined between the step 34 and an upper surface of shoulder 36 may be relatively small and act to compress and unify the bread layers of a sandwich when the sandwich maker 25 is in the closed position. The cutting and sealing portion and operations of the sandwich maker 25 may be substantially similar to those shown and described in various embodiments of co-pending U.S. patent application Ser. No. 11/615,725, filed Dec. 22, 2006, which is commonly owned, and the disclosure of which is incorporated herein in its entirety.

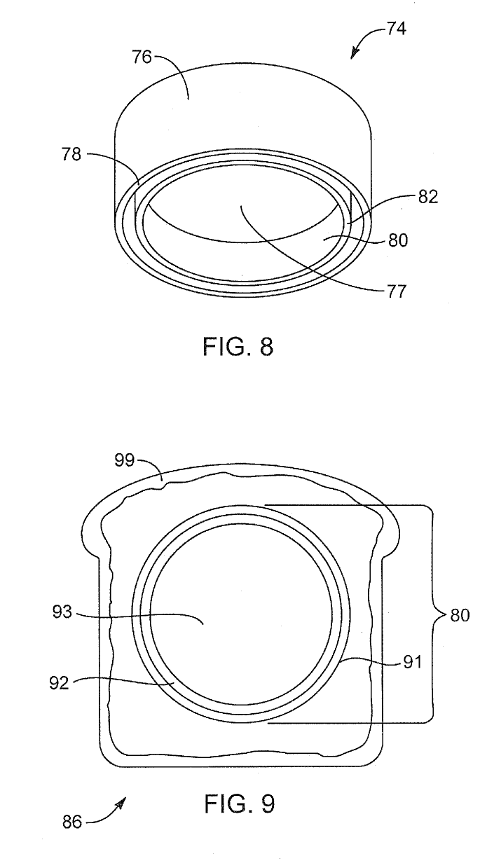

FIG. 6 is a bottom diagrammatic perspective view of a sandwich maker 38 that presses sandwiches into predetermined shapes and sizes. It has a cutting edge 40 similar to those described above. The sandwich maker 38 has a food surrounding portion 42, defined at least in part by a top wall 44 and a downwardly extending wall 46 that also provides the cutting edge 40. The sandwich maker 38 may include one or more optional removably coupled indenting and marking elements 48 that provide one or more predetermined image makers 50 from which a user can choose to selectively provide any of a variety of images on a surface of the sandwich. Image maker 50 is present in the illustration to show how markings can be left on the bread. In the illustrated embodiment of FIG. 6, the sandwich maker 38 does not necessarily seal the cut edge of sandwiches. However, the step configuration shown and described with regard to FIG. 4 or other structure may be applied to this embodiment to provide sealing and cutting. As with the embodiment of FIG. 4, the sandwich maker 38 has no moving parts, and the indenting and marking element(s) 48 can include detachable coupling mechanisms for directly mounting the element(s) 48 to a substantially rigid or solid piece of material such as the top wall 44. For example, the indenting and marking elements may include magnets or suction cups configured to interact with the top wall 44. Alternatively, the indenting and marking elements may include a post and the top wall may include receivers configured to frictionally or snappingly receive the posts to detachably couple the indenting or marking elements 48.

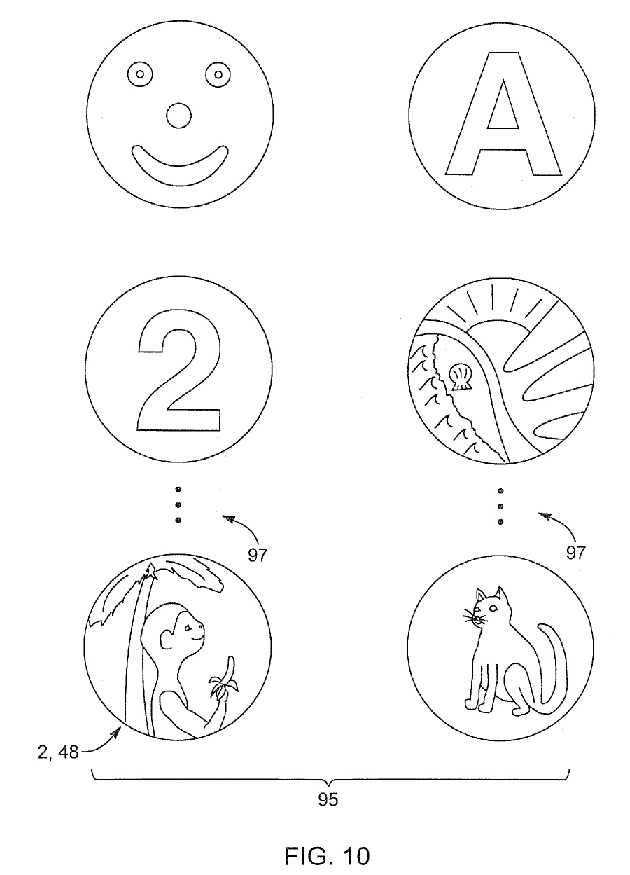

FIG. 7 is a perspective view of a sandwich maker 52 similar to the sandwich maker 38 of FIG. 5. The sandwich maker 52 may be more broadly termed a food molder 52 that can fully surround food and leave indentations, markings, embossments, and the like. In this particular embodiment, the marking element(s) 48 may include one or more suction cups that provide detachable coupling mechanisms for coupling the marking element(s) 48 to inner surfaces of one or both of a pair of tools 54, 56. The tools 54, 56 may include respective handle portions 58, 60 that extend from respective food receiving compartments 62, 64. The two handle portions 58, 60 or food receiving compartments 62, 64 may be pivotally coupled together by a pivot pin 66, for example, to allow the tools 54, 56 to pivot between an opened and a closed position of the device 52.

Thus, food can be placed in one food receiving compartment 64 and the other food receiving compartment 62 can be rotated down into a surrounding relationship with the food. A user can apply an appropriate amount of pressure to one tool 54 relative to the other tool 56 to perform cutting and/or sealing operation(s) as described above. Additionally, one or more marking elements 48 can optionally be coupled to surfaces 68, 70, as indicated by dashed line 72. The marking elements 48 may include a multitude of different images and marking mechanisms for marking a multitude of different food products. For example, the sandwich maker 52 can be applied to shaping, embossing, and/or marking scones, fruit, potatoes, and refried beans. The food receiving compartments 62, 64 can surround and press the selected food when the device 52 is placed in the closed position. Even though the sandwich maker 52 is described herein for the use in preparing shaped or marked food, the same concept can also be applied to configuring devices to be utilized on non edible products. For example, and without limitation, the devices in accordance with alternative embodiments of the present invention may be utilized for shaping sand, shaping cement, and/or metal.

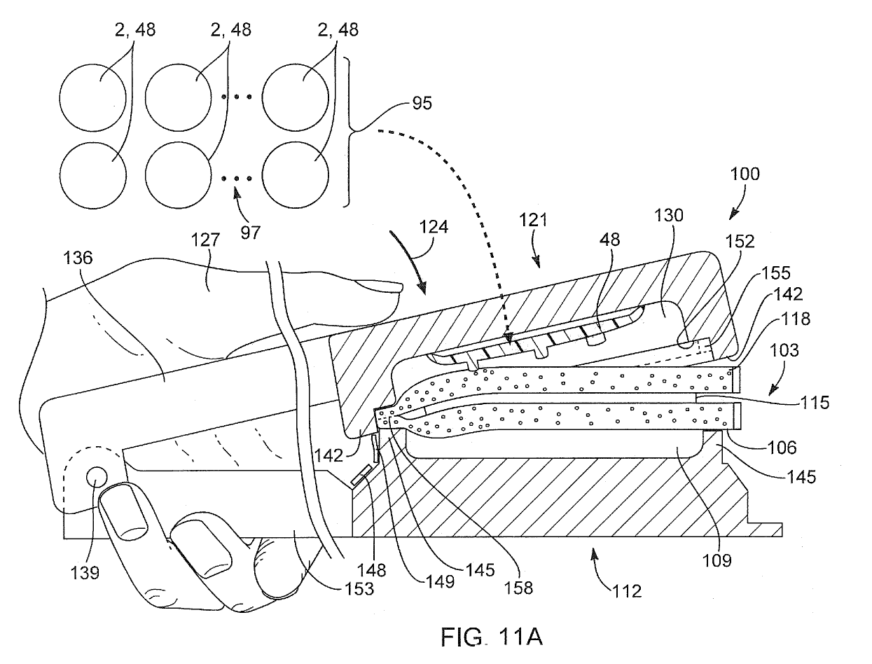

FIG. 8 is a bottom perspective view of a sandwich maker 74 in accordance with another embodiment of the present invention. The sandwich maker 74 has a first outer wall 76 that provides a cutting edge 78 at its lower end for cutting and removing an outer edge and/or crust of the bread being used to make the sandwich. The sandwich cutter 74 also has a second inner wall 80 for compressing and sealing an outer edge of the sandwich being made. The inner wall 80 has a specific height recessed from a lower edge of the outer wall 76 to enable sealing compression of bread slices near or adjacent to the cut edge while the outer wall severs the crust when pressed against a cutting surface. Thus, a lower face 82 of the inner wall 80 compresses and unites layers of bread at a periphery, forming a pocket around a food filling. A top wall 84 and inner surfaces of the inner wall 80 form a food receiving compartment to enable formation of the pocket without smashing the filling or bursting the pocket. One or more marking elements may also be utilized with the sandwich maker 74, as set forth with regard to the other embodiments disclosed above.

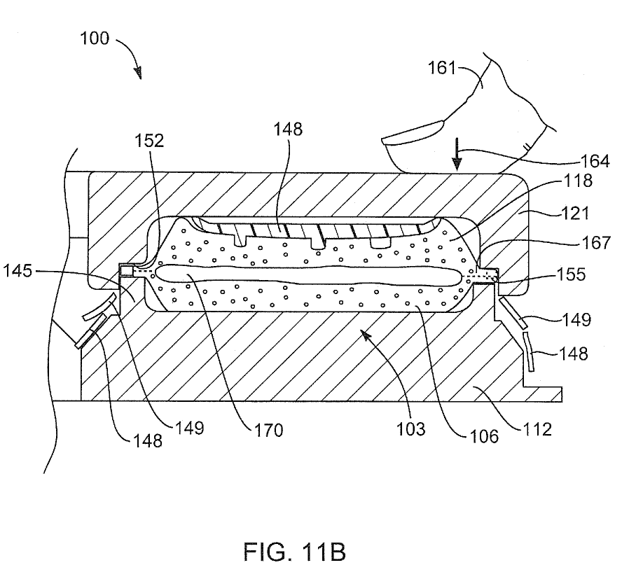

FIG. 9 is a diagrammatic top plan view of a sandwich 86 showing an example of cut and sealed portions formed by the two walled sandwich maker 74 of FIG. 8. The sandwich 86 includes a crustless sealed sandwich 80, which is shown with its outer crust 99 not pulled away from a cut edge 91. A sealed area 92 was formed by the pressing of the a lower edge 82 of the inner wall 80 into the layers of bread forming the sandwich 86, while the cutting edge 78 of the outer wall 76 cut through the bread at the cut edge 91. Pressing the sealed area actually results in uniting of two or more layers of bread forming the sandwich. Thus, a filling pocket 93 is formed that encloses and holds filling ingredients within the sealed sandwich edge.

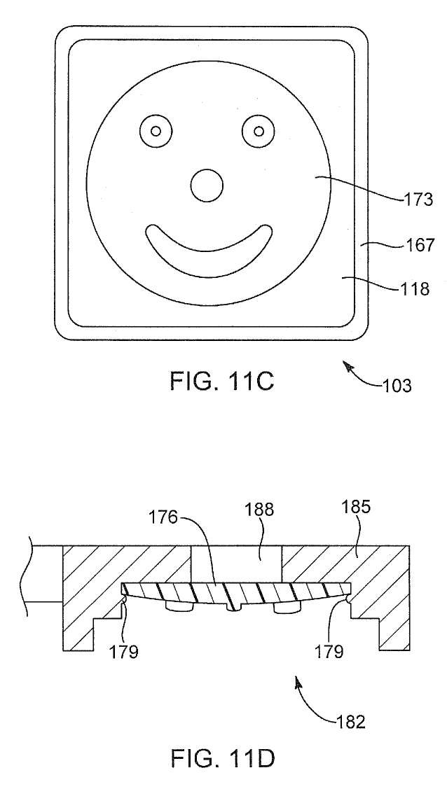

FIG. 10 is a diagrammatic view of a plurality of predetermined indenting or marking elements 2, 48 forming a set 95 from which a user can select. In the illustrated set 95, there is a smiley face, a letter, a number, a logo, a monkey, and a cat. Fewer or additional marking elements 2, 48 may make up the set 95 as indicated by the ellipses 97. While shown as round elements, it is to be understood that the marking elements 2, 48 may be of any configuration or may include plural elements for positioning in one or each of the tools of embodiments of the present invention. The images may include educational images that help teach or reinforce facts. Images may be included to elicit particular emotions. For example, fun or happy emotions can be stimulated by a fun or happy image such as a cartoon image. Thus, a user can promote association of fun or happy emotions with making and eating sandwiches, for example.

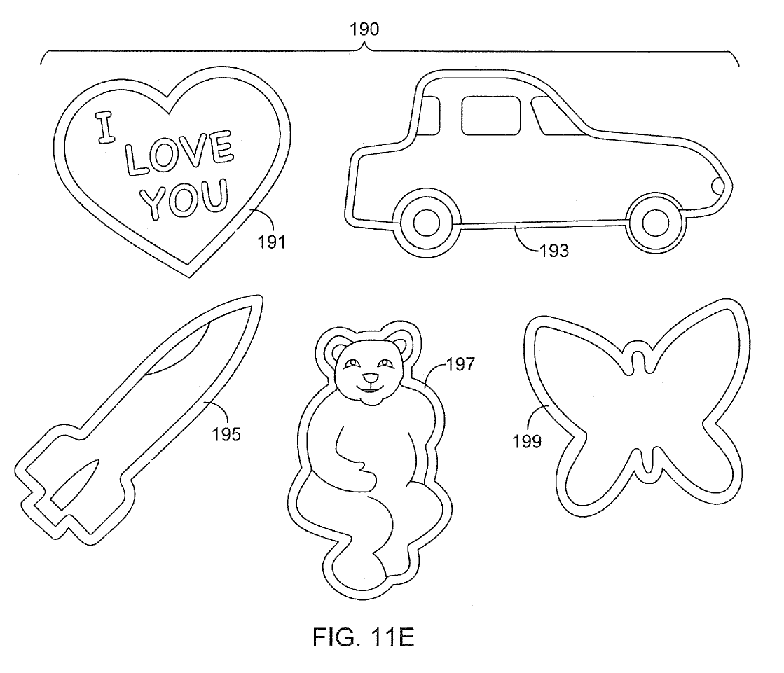

FIG. 11A is a diagrammatic partial sectional view of an embodiment of a sandwich maker 100 being used to cut and seal a sandwich 103 in accordance with a method of the present invention. As may be appreciated, a first slice of bread 106 may be placed in overlying relation to a food receiving compartment 109 of a first tool 112 of the sandwich maker 100. Then and edible filling material 115 may be placed atop the first slice of bread 106, and a second slice of bread 118 may be placed atop the filling material 115. A second tool 121 may be moved from an open position toward a closed position as indicated by arrow 124 by a gripping force applied by a user's hand 127, for example. Movement of the second tool 121 in the direction of arrow 124 brings a second food receiving compartment 130 into engagement with the second slice of bread 118. First and second handles 133, 136 forming part of the first and second tools 112, 121 respectively, may extend from portions having the first and second food receiving compartments 109, 130. To aid in guiding the tools 112, 121, a pivot pin 139 may pivotally connect the first and second tools 112, 121 at a proximal end of the handles 133, 136 such that the sandwich maker 100 functions similar to a pair of tongs.

Prior to closing the sandwich maker 100, a marking element 48 may be selected from a set 95 of marking elements 48. The set 95 may include a plurality of marking elements 48, a plurality of marking elements 2, and/or other marking elements configured to function with any of a variety of sandwich makers or other devices. In FIG. 11A, the marking element 48 disposed in the device 100 is shown in cross-section as providing a releasable coupling mechanism in the form of a suction cup that can be attached to a surface of one or both food receiving compartments 109, 130. Once the layers of the sandwich 103 have been placed in overlying relation to the food receiving compartment 109, and any marking elements 48 have been placed in the food receiving compartments 109, 130, the handles 133, 136 may be gripped to force the compartments 109, 130 into surrounding relation with the sandwich 103. In this process, a shoulders 142 surrounding the second food receiving compartment 130 moves past a shoulder 145 surrounding the first food receiving compartment 109 and shears off crusts 148, 149 from the first and second slice is of bread 106, 118, respectively. A crimping face 152 and/or an additional step 155 on the second tool 121 pinch at least two layers of bread together against an upper surface of shoulder 145 of the first tool 112. The sandwich maker 100 facilitates application of just the right amount of force and compression of the layers of bread into an appropriate volume that causes the layers to unite and form a seal at a location indicated by the dashed line 158.

As shown in the partial sectional view of FIG. 11B, additional force may be applied by pressing a thumb or finger 161 on an upper surface of the second tool 121 in a direction of arrow 164. As may be appreciated from the illustration FIG. 11B, by moving the sandwich maker 100 to the fully closed position, the crusts 148, 149 are completely severed from the rest of the sandwich 103 and are permitted to fall away. An outer or peripheral edge 167 is crimped and sealed between the crimping face 152 and an upper face of the shoulder 145. Alternatively or additionally, a step 155 shown in dashed lines may crimp and seal the edge. In any case, an edible filling material 170 is sealed inside a pocket between the layers or slices of bread 106, 118. At the same time, the marking element 48 is pressed into an upper surface of the second slice of bread 118, forming an indented image 173, as shown in the top plan view of the resulting sandwich 103 shown in FIG. 11C. While the cut or sheared and sealed edges are shown in a generally rectangular configuration, it is to be understood that other configurations are possible by providing shoulders and crimping faces having outlines of other shapes, including outlines for cartoon characters or other images.

It is to be understood that additionally or alternatively a marking element 48 could be placed on a bottom surface of the food receiving compartment 109 of the first tool 112. Furthermore, it is to be understood that although the coupling mechanism shown in FIGS. 11A and 11B includes a suction cup, other coupling mechanisms such as that shown in the partial sectional view FIG. 11D may be incorporated into the device. FIG. 11D shows an alternative embodiment of a portion of the second tool of FIGS. 11A and 11B and an alternative marking element 176 generally in a disk configuration. In this embodiment, the first and second tools may include one or more protrusion 179 in a food receiving compartment 182 of the alternative second tool 185. In this embodiment, a through opening 188 is provided through the second tool 185 to enable a user to insert his or her finger for the purpose of pressing on the marking element 176 in order to remove it from the food receiving compartment 182. Other mechanisms and structures may be implemented for retaining and detaching marking elements including, but not limited to, magnets, snap fits, and/or friction fits. Further alternatively, no coupling mechanism need be used when only one marking element is utilized and is placed in the food receiving compartment 109 of the first tool 112.

It is to be understood that a depth of embossing or imprinting may selectively be controlled by any of a variety of mechanisms, which may be incorporated with embodiments of the present invention. For example, utilizing principles of the embodiment of FIG. 11D, one or more spacers may be utilized to position the marking elements 48, 176 to press further into the food product. Alternatively, the marking elements may be supported on the tools 112, 121, 185 by adjustable coupling mechanisms that may include helical threaded structure or plural detents for selectively positioning the marking elements to adjustably engage food products to greater or lesser depths. This feature is useful for creating deeper impressions or for accommodating food products having greater or lesser thicknesses, for example. At the same time, the food products can still be cut and sealed simultaneously with the marking operation.

FIG. 11E is a diagrammatic view showing examples of alternative embodiments 190 of outlines that can be applied to food receiving compartments 109, 130, 182, crimping faces 152, and shoulders 142, 145 for a variety of tool configurations and resulting prepared food product outlines analogous to the outline of peripheral edge 167 shown in FIG. 11C. Thus, outlines 191, 193, 195, 197, and 199 shown in FIG. 11E represent examples of the configurations of respective compartments, crimping faces, shoulders, and resulting peripheral edges on prepared food products. The relationship between the shoulders, crimping faces, compartments, and the peripheral edges are generally the same as those shown and described with regard to the other embodiments disclosed herein. As shown, additional details may be applied to the images through embossing details on inner surfaces of the compartments or through removable marking elements as has been described herein. For example, a tool or tools could be used to form a bun or other food product around a hotdog and have an outline 195 of a space ship. Additional details such as the tail fin cockpit could be imprinted or embossed on the food product by a surface of the compartment or by a removable marking element. As may be appreciated, the configurations of the outlines shown in FIG. 11E are examples only. Any of a variety of other configurations may be utilized without limitation. On the other hand, some configurations lend themselves to typical shapes in which certain food products are available such as elongate, round, triangular, generally square or rectangular, for example.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Each of the steps shown is not included in all of the embodiments. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

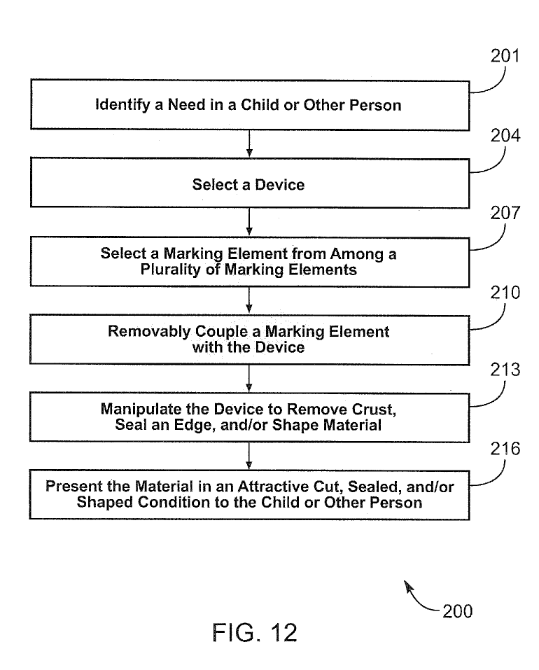

FIG. 12 is a block diagram depicting a method 200 in accordance with an embodiment of the present invention. Embodiments of the method may include one or more of shearing, sealing and marking as described above. However, embodiments of the method may also include operations in addition to marking, sealing edges, and removing crusts of bread or sandwiches. For example, the method may include identifying a need in a child or other person, as indicated at 201. The identified need may be for a child or other person to develop a greater interest in food or eating. Another identified need could be the need to better containing food within the sandwich. An additional or alternative need may be to condition a child or other person to associate eating with fun or a sense of having fun. A parent or caretaker may determine that a child or other person has a need for a tactile experience, or perhaps there is a need to teach or reinforce a fact such as the appearance of a number or letter, which the child can think about while eating. As a solution to a problem or to meet the identified need, the user may select a device, as indicated at 204. The device selected may be any of the devices in accordance with embodiments described herein or other similar devices.

Depending upon the device selected, the device may include a set of marking elements for shaping, embossing, coloring, and/or otherwise marking. Thus, embodiments of the invention may include selecting a marking element from among a plurality of marking elements, as indicated at 207. Selecting a marking element may include at least one of teaching, learning, and reaffirming a fact. Alternatively or additionally, selecting a marking element may include at least one of teaching, learning, or reaffirming an emotion in association with material to be marked. Advantageously, the embodiments of the method may include involving the child or other person who is the intended beneficiary in the selection process.

Once the marking element has been selected, embodiments of the method may include removably inserting the marking element into a food surrounding recess or receiving compartment, as indicated at 210. Embodiments of the method may include the steps of placing sandwich layers including slices and/or filling material on a cutting surface such as a counter or tool for one or more of crust removal, edge sealing, and marking, as described above. Embodiments may further include manipulating a device and/or marking element to perform one or more of the operations of removing the crust, sealing an edge, and marking or shaping bread or other materials, as indicated at 213. Thus, embodiments of the method may include marking or stamping bread with a stamp, cookie-cutter type device, and/or pair of tools configured generally as a set of tongs. The embodiments may include clamping food between two tools by a gripping action. The embodiments may also include sealing an edge and shaping a food simultaneously by a single action. In some embodiments, the method includes removing a crust by the same single action that also causes sealing and shaping of the bread and/or food. Finally, the embodiments of the present invention may include presenting a sandwich or other food in an attractive cut, sealed, and/or shaped condition to a child or other person, as indicated at 216.

While the embodiments have been described predominantly in terms of forming a sealed sandwich having slices or layers of bread, it is to be understood that the devices, systems, and methods of the present invention may be used to cut, shape, and seal any of a variety of other food products. These food products may include, but are not limited to, dough products, pasta products, pizza or pizza products, fruits, cheeses, pies, scones, brownies, desserts, etc. Shapes may be applied to single or plural layers of these food products to form prepared food products with or without sealed pockets. The sealed pockets may include any of a variety of filling material including one or more of sandwich makings, meat, cheese, hotdog, salad material, dressing, stuffing, sauce, fruit, vegetable, syrup, honey, butter, jam, pudding, cream, etc. without limitation.

The tools, devices, and marking elements of embodiments of the present invention can be formed of any of a variety of materials including molded or otherwise shaped plastics, silicone or ABS rubber, metals, wood, composites, and/or combinations thereof without limitation. The various components can be formed as one piece or as plural pieces fit together during manufacturing or by a user. Components that are intended to be detachable, such as releasable marking elements, may be provided as sets for selective use with other elements such as the tools. Hinges described herein may be provided by structure including pins and journals. Alternatively, the hinges may be provided by living hinges. Other alternative structure may be incorporated. For example, the pivotal connections shown and described herein may be replaced by slidable connection and still be within the spirit and scope of the present invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A device for marking images onto sandwich bread, comprising:
a tool having a mechanism for shearing a crust from baked, sliced bread;
the tool having a mechanism for sealing a sheared edge of the sliced bread; and
an image marking element on the tool, the image marking element configured to imprint an image into an outer surface of at least one bread slice.

2. The device of claim 1, wherein the image marking element is a first image marking element of a plurality of image marking elements, the first image marking element removably coupled to the tool by a releasable coupling mechanism, enabling a multitude of imaging and embossing options.

3. The device of claim 2, wherein the releasable coupling mechanism includes at least one suction cup.

4. The device of claim 1, wherein the image marking element further comprises a coloring mechanism.

5. The device of claim 1, wherein the tool has at least one shearing edge configured to remove a portion of a slice of bread to leave a remainder of the slice of bread in a shape forming an image.

6. The device of claim 1, wherein the shearing mechanism and the sealing mechanism simultaneously shear and seal bread to form a pocket within the bread.

7. The device of claim 6, wherein the shearing mechanism, the sealing mechanism, and a marking mechanism comprising the marking element simultaneously shear, seal, and mark bread to form a sandwich having a pocket containing a filling on an inside and an image on an outside of the sandwich.

8. The device of claim 1, wherein the device has no moving parts.

9. The device of claim 1, wherein the tool is a first tool, the device has at least two parts comprising the first tool and a second tool that move relative to each other in order to facilitate shearing and sealing.

10. The device of claim 1, wherein the device is a sandwich maker that has a first wall for shearing bread and a second wall for sealing a sheared edge of the bread to form a prepared sandwich.

11. A system for forming a shaped and sealed edge food product, comprising:
a hand held device including:
an upper tool having at least one blunt shearing edge forming an outline of a predetermined familiar image configured to elicit positive emotion when perceived, the upper tool configured to be brought down upon a food product resting on a counter or a lower tool to sever a portion of the food product in order to leave the outline of the image on a prepared food product;
at least one crimping face on the upper tool, the at least one crimping face surrounded by the at least one blunt shearing edge, the crimping face configured to press layers of the food product together around a food product filling to form the prepared food product with a sealed pocket of filling between the layers; and
at least one recess in the upper tool, the at least one recess surrounded by the at least one blunt shearing edge and positioned inwardly of the at least one crimping face, the at least one recess configured to shape the food product in order to form an image on an outer surface of the prepared food product;
wherein blunt sheering edge, the crimping face, and the recess have relative structure that causes shearing, sealing and shaping to occur simultaneously when the hand held device is brought down on the food product and pressed against the counter or lower tool such that a fun prepared food product having an outline of the predetermined familiar image, a sealed pocket of filling within, and a shaped image on the outer surface is formed by the hand held device.

12. The system of claim 11, wherein the food product comprises one or more of a dough product, a pasta product, and a bread product.

13. The system of claim 12, wherein the prepared food product has the outline of the image from a group consisting of a vehicle, a symbol, and an animal.

14. The system of claim 11, wherein:
the upper tool is a first upper tool that includes the at least one blunt shearing edge, the at least one crimping face, and the at least one recess;
the at least one blunt shearing edge is a first blunt shearing edge, the at least one crimping face is a first crimping face, and the at least one recess is a first recess;
the device further comprising a second lower tool that includes a second blunt shearing edge, a second crimping face surrounded by the second blunt shearing edge, and a second recess surrounded by the second blunt shearing edge and positioned inwardly of the second crimping face.

15. The system of claim 11, further comprising:
a set of detachable marking elements;
a releasable coupling mechanism on the hand held device and the detachable marking elements for releasably coupling the marking elements to the device.

16. The system of claim 15, wherein the set of detachable marking elements comprises images of one or more of a cartoon, letter, word, number, logo, and a human interest image.

17. The system of claim 16, wherein the images on the marking elements are related to the outline of the image in order to form a matching overall image shape and outline for the prepared food product.

18. The system of claim 15, wherein the coupling mechanism comprises at least one suction cup on the marking elements and at least one of the tools having a smooth surface for removably receiving the suction cup.

19. A method of making a sandwich, comprising:
Providing a tool having a mechanism for shearing a crust from baked, sliced bread;
the tool having a mechanism for sealing a sheared edge of the sliced bread;
providing an image marking element on the tool, the image marking element configured to imprint an image into an outer surface of at least one bread slice; and
simultaneously shearing away portions of the sandwich, sealing an outer edge of the sandwich, and placing an image on an outer surface of the sandwich.

20. The method of claim 19, further comprising selecting a marking element from a set of marking elements based on the need.

21. The method of claim 20, further comprising removably coupling the marking element to a surface in a food receiving recess of the tool.

22. The method of claim 21, wherein simultaneously shearing, sealing, and placing comprises manipulating the tool.

23. The method of claim 22, wherein placing further comprises shaping a surface of the sandwich.

24. A system for forming a sealed edge food product, comprising:
a hand held device including:
an upper tool having at least one blunt shearing edge, the upper tool configured to be brought down upon a food product resting on a counter or a lower tool;
at least one crimping face on the upper tool, the at least one crimping face surrounded by the at least one blunt shearing edge; and
at least one recess in the upper tool, the at least one recess surrounded by the at least one blunt shearing edge and positioned inwardly of the at least one crimping face.

25. The system of claim 24, wherein:
the upper tool is a first upper tool that includes the at least one blunt shearing edge, the at least one crimping face, and the at least one recess;
the at least one blunt shearing edge is a first blunt shearing edge, the at least one crimping face is a first crimping face, and the at least one recess is a first recess;
the device further comprising a second lower tool that includes a second blunt shearing edge, a second crimping face surrounded by the second blunt shearing edge, and a second recess surrounded by the second blunt shearing edge and positioned inwardly of the second crimping face.

26. The system of claim 24, further comprising:
a set of detachable marking elements;
a releasable coupling mechanism on the hand held device and detachable marking elements for releasably coupling the marking elements to the device.

27. The system of claim 26, wherein the releasable coupling mechanism comprises at least one suction cup on the marking elements and at least one of the tools having a smooth surface for removably receiving the suction cup.
